(19) United States
(12) Patent Application Publication
(10) Pub. No.: US 2022/0164569 A1
(43) Pub. Date: May 26, 2022

(54) ACTION RECOGNITION METHOD AND APPARATUS BASED ON SPATIO-TEMPORAL SELF-ATTENTION

(71) Applicant: POSTECH Research and Business Development Foundation, Pohang-si (KR)

(72) Inventors: Dai Jin KIM, Pohang-si (KR); Myeong Jun KIM, Pohang-si (KR)

(21) Appl. No.: 17/512,544

(22) Filed: Oct. 27, 2021

(30) Foreign Application Priority Data
Nov. 26, 2020 (KR) 10-2020-0161680

(51) Int. Cl. G06K 9/00; G06K 9/62

(52) U.S. Cl. CPC G06K 9/00335; G06K 9/00362; G06K 9/6232

(57) ABSTRACT

The present disclosure provides an action recognition method including: acquiring video features for input videos; generating a bounding box surrounding a person who may be a target for an action recognition; pooling the video features based on bounding box information; extracting at least one spatial feature map from pooled video features; extracting at least one temporal feature map from pooled video features; concatenating the at least one spatial feature map and the at least one temporal feature map to generate a concatenated feature map; and performing a human action recognition based on the concatenated feature map.

### CROSS-REFERENCE TO RELATED APPLICATION

The present application claims a convention priority based on Korean Patent Application No. 10-2020-0161680 filed on Nov. 26, 2020, with the Korean Intellectual Property Office (KIPO), the entire content of which is incorporated herein by reference.

### BACKGROUND

### 1. Technical Field

The present disclosure relates to an action recognition method and apparatus and, more particularly, to a method and apparatus for recognizing a human action by using an action recognition neural network.

### 2. Related Art

An action recognition, which locates a person in videos to recognize an action what the person is doing, is a core technology in the field of computer vision that is widely being used in various industries such as video surveillance cameras, human-computer interactions, and autonomous driving. One of the most widely used methods of recognizing the human action is an object-detection based recognition. The action recognition requires to discriminate complex and various motions contained in the videos, and is associated with many complicated real-world problems that must be addressed.

Deep Convolutional Neural Networks (CNN) have achieved great performances in image classification, object detection, and semantic segmentation. Attempts are being made to apply the CNNs to the action recognition, but progress is slow partly because many of human actions are associated with other person or objects and the recognition thereof is difficult using only local features. Human actions may be divided into three categories: person movement, object manipulation, and person interaction. Thus, in order to recognize the human action, the interactions with the objects and/or other person should be taken into account.

### SUMMARY

Provided is a method and apparatus for recognizing a human action taking the interactions with objects and/or other person into account.

Provided is a method and apparatus for recognizing the human action by applying a self-attention mechanism to extract a feature map in a spatial axis domain and a feature map in a temporal axis domain to recognize the human action by using all the feature maps.

According to an aspect of an exemplary embodiment, an action recognition method includes: acquiring video features for input videos; generating a bounding box surrounding a person who may be a target for an action recognition; pooling the video features based on bounding box information; extracting at least one spatial feature map from pooled video features; extracting at least one temporal feature map from pooled video features; concatenating the at least one spatial feature map and the at least one temporal feature map to generate a concatenated feature map; and performing a human action recognition based on the concatenated feature map.

Pooling of the video features may be performed through RoIAlign operations.

Extracting of at least one spatial feature map may include a process of generating a feature map for a spatially fast action and a process of generating a feature map for a spatially slow action.

Extracting of at least one temporal feature map may include a process of generating a feature map for a temporally fast action and a process of generating a feature map for a temporally slow action.

Each of the process of generating the feature map for the spatially fast action and the process of generating the feature map for the spatially slow action may include: projecting the pooled video features into two new feature spaces; calculating a spatial attention map having components representing influences between spatial regions; and obtaining a spatial feature vector by performing a matrix multiplication of the spatial attention map with input video data.

Each of the process of generating the feature map for the spatially fast action and the process of generating the feature map for the spatially slow action may further include: generating the spatial feature map by multiplying a first scaling parameter to the spatial feature vector and adding the video feature.

Each of the process of generating the feature map for the temporally fast action and the process of generating the feature map for the temporally slow action may include: projecting the pooled video features into two new feature spaces; calculating a temporal attention map having components representing influences between temporal regions; and obtaining a temporal feature vector by performing a matrix multiplication of the temporal attention map with the input video feature.

Each of the process of generating the feature map for the temporally fast action and the process of generating the feature map for the temporally slow action may further include: generating the temporal feature map by multiplying a second scaling parameter to the temporal feature vector and adding the video feature.

According to another aspect of an exemplary embodiment, an apparatus for recognizing a human action from videos includes: a processor and a memory storing program instructions to be executed by the processor. When executed by the processor, the program instructions causes the processor to acquire video features for input videos; generate a bounding box surrounding a person who may be a target for an action recognition; pool the video features based on bounding box information; extract at least one spatial feature map from pooled video features; extract at least one temporal feature map from pooled video features; concatenate the at least one spatial feature map and the at least one temporal feature map to generate a concatenated feature map; and perform a human action recognition based on the concatenated feature map.

The program instructions causing the processor to pool the video features may cause the processor to pool the video features through RoIAlign operations.

The program instructions causing the processor to extract the at least one spatial feature map may include instructions causing the processor to: generate a feature map for a spatially fast action; and generate a feature map for a spatially slow action.

The program instructions causing the processor to extract the at least one temporal feature map may include instructions causing the processor to: generate a feature map for a temporally fast action; and generate a feature map for a temporally slow action.

The program instructions causing the processor to generate the feature map for the spatially fast action the program instructions causing the processor to generate the feature map for the spatially slow action may include instructions causing the processor to: project the pooled video features into two new feature spaces; calculate a spatial attention map having components representing influences between spatial regions; and obtain a spatial feature vector by performing a matrix multiplication of the spatial attention map with input video data.

Each of the program instructions causing the processor to generate the feature map for the spatially fast action the program instructions causing the processor to generate the feature map for the spatially slow action further may include instructions causing the processor to generate the spatial feature map by multiplying a first scaling parameter to the spatial feature vector and adding the video feature.

Each of the program instructions causing the processor to generate the feature map for the temporally fast action the program instructions causing the processor to generate the feature map for the temporally slow action may include instructions causing the processor to: project the pooled video features into two new feature spaces; calculate a temporal attention map having components representing influences between temporal regions; and obtain a temporal feature vector by performing a matrix multiplication of the temporal attention map with the input video feature.

Each of the program instructions causing the processor to generate the feature map for the temporally fast action the program instructions causing the processor to generate the feature map for the temporally slow action may further include instructions causing the processor to generate the temporal feature map by multiplying a second scaling parameter to the temporal feature vector and adding the video feature.

Since the self-attention mechanism according to an exemplary embodiment of the present disclosure recognizes the human action using both the spatial feature map and the temporal feature map, the human action may be recognized by taking into account a person's hand, face, objects, and other person's features. In addition, since the feature map is extracted by reflecting the features of both the slow action and fast action, it is possible to properly distinguish differences in characteristic features according to genders and ages of persons. Performance improvement was confirmed in 44 of the 60 evaluation items compared to a basic action recognition algorithm. In addition, the performance improvement may be achieved by a simple network structure.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram showing an overall structure of a spatio-temporal self-attention network according to an exemplary embodiment of the present disclosure;

FIG. 2 is a block diagram of an action recognition apparatus according to an exemplary embodiment of the present disclosure;

FIG. 3 is a flowchart showing the action recognition method according to an exemplary embodiment of the present disclosure;

FIG. 4 is an illustration for explaining a process of generating the feature map for the spatially slow action;

FIG. 5 is an illustration for explaining a process of generating the feature map for the spatially fast action;

FIG. 6 is an illustration for explaining a process of generating the feature map for the temporally slow action;

FIG. 7 is an illustration for explaining a process of generating the feature map for the temporally fast action;

FIG. 8 is a table summarizing performance evaluation results of the action recognition method of the present disclosure and conventional methods performed using the AVA dataset; and

FIGS. 9A and 9B are graphs showing comparison results of the frame APs for the cases with and without the spatio-temporal self-attention mechanism according to the present disclosure.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

In the following description, in order to facilitate an overall understanding thereof, the same components are assigned the same reference numerals in the drawings and are not redundantly described here.

Researches for analyzing and localizing human behavior in video data have recently been accelerated. Most common datasets used for training or evaluating such researches may include Kinetics and UCF-101. A dataset may include a person movement, human-to-human interaction, and human-object interaction. As new data come out, understanding the relationships between people and the association between people and objects has become a critical factor in action recognition and it is also important to be aware of the situation appropriately. There were several approaches for action recognition. In some of the approaches, human joints information are found through human pose estimation, while another approach judging human action by capturing how each joint moves with temporal axis. Some other networks use more abundant information by fusion of video and optical flow features. However, the recent trend is solving the action recognition using only video clips.

A self-attention mechanism, which is widely used in a field of natural language processing than Recurrent Neural Networks (RNNs), reveals good performances in the fields of machine translation and image captioning. The self-attention mechanism is expected to reveal noticeable performance improvements and expand its use in many other fields as well.

A general self-attention mechanism performs a matrix operation of a key feature vector and a query feature vector to find a relationship between three feature vectors, the key, the query, and a value, and extracts an attention map taking into account a long range interaction through a softmax operation. The extracted attention map serves as an index for determining the relationship of each element with other elements in the input data. Finally, the attention map is subj ected to a matrix multiplication with the value feature vector so that the relationship is reflected.

The action recognition of the present disclosure applies the self-attention mechanism taking into account the long-range interaction to an action recognition problem, and uses temporal information along with spatial information when applying the self-attention mechanism to the video action recognition problem.

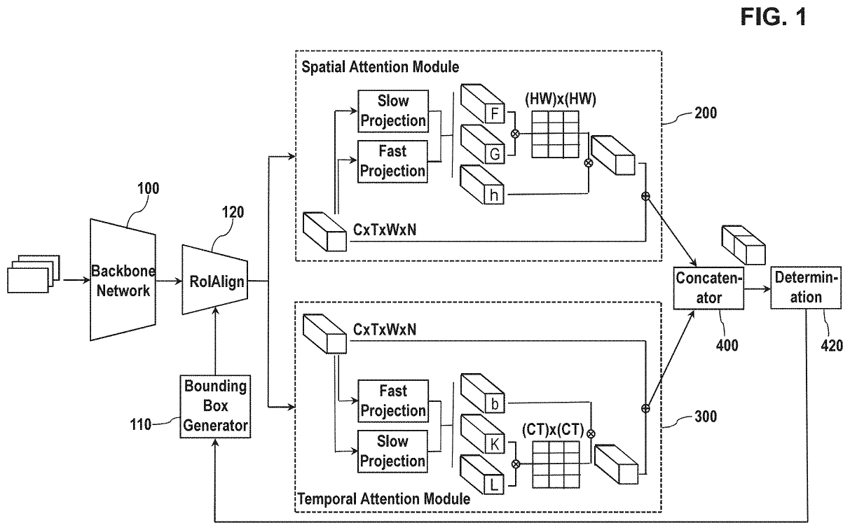

FIG. 1 is a block diagram showing an overall structure of a spatio-temporal self-attention network according to an exemplary embodiment of the present disclosure. The spatio-temporal self-attention network shown in the drawing includes a backbone network 100, a bounding box generator 110, a region-of-interest (RoI) alignment unit 120, a spatial attention module 200, a temporal attention module 300, a concatenator 400, and a determination unit 420.

The backbone network 100 receives a certain number of video frames as one video data unit and extracts features of the input videos. The video data unit may include 32 video frames, for example. The backbone network 100 may be implemented by a Residual network (ResNet) or an Inflated 3D convolutional network (I3D) pre-trained with Kinetics-400 dataset, for example.

The bounding box generator 110 finds a location of a person in the video who may be a target of the action recognition, based on the input video features output by the backbone network 100, and generates a bounding box surrounding the person. Also, the bounding box generator 110 may update a position and size of the bounding box by performing regression operations with reference to a feature map output by the concatenator 400. The bounding box generator 110 may be implemented based on a Region Proposal Network (RPN) used in a Fast Region-based Convolutional Neural Networks (Fast R-CNNs).

The RoI alignment unit 120 may pool the video features from the backbone network 100 through RoIAlign operations with reference to the bounding box information from the bounding box generation unit 110.

The spatial attention module 200 extracts a feature map for an area to be intensively considered on a spatial axis domain from the RoIAligned video features. In particular, the spatial attention module 200 may separately extract a spatial slow action self-attention feature map and a spatial fast action self-attention feature map. While conventional self-attention mechanisms were used to identify relationships between pixels in an image, an exemplary embodiment of the present disclosure uses the spatial self-attention mechanism to extract spatially significant regions from the video features. For this purpose, the spatial attention module 200 is pre-trained to focus on the video features (e.g., a hand or face) that are useful for determining the human action from the video features.

The temporal attention module 300 extracts a feature map for an area to be intensively considered on a temporal axis domain from the RoIAligned video features. In particular, the temporal attention module 300 may separately extract a temporal slow action self-attention feature map and a temporal fast action self-attention feature map. In general, there is a difference in the amount of information that may be obtained from the input frames constituting the input video between feature vectors at a point where the human action starts or ends and a feature vector while the action is in progress. Therefore, the temporal attention module 300 may extract the feature vector useful for determining the human action from the video features when viewed from the temporal axis domain.

The concatenator 400 may concatenate all the feature maps extracted by the spatial attention module 200 and the temporal attention module 300 to create a concatenated feature map, and the determining unit 420 performs the human action recognition based on the concatenated feature map. Considering that the human action is complex, a dichotomous cross-entropy may be applied for each behavior so that an action may be recognized as the human action if a determination value is higher than a threshold according to an exemplary embodiment of the present disclosure.

The spatial attention module 200 and the temporal attention module 300 will now be described in more detail.

The spatial attention module 200 may receive the video features having a shape of C×T×H×W from the backbone network 100 through the RoI alignment unit 120, where C, T, H, W denote a number of channels, a temporal duration, a height, and a width, respectively. The spatial attention module 200 transforms the video features into C×T first features and H×W second features. The data transformation may be performed by a separate member other than the spatial attention module 200. Alternatively, the data transformation may just mean a selective use of only some portion of the video features stored in the memory rather than an actual data manipulation. Here, ‘C×T’ may represent a number of feature channels and temporal spaces, and ‘H×W’ may represent a number of spatial feature maps.

The spatial attention module 200 projects the transformed video features x ∈ R^{(C×T)×(H×W)} into two new feature spaces F, G according to Equation 1. This projection corresponds to a multiplication of a key matrix by a query matrix in the spatial axis domain.

$$F ( x ) = {W}_{F} x , G ( x ) = {W}_{G} x \qquad [ Equation 1 ]$$

Subsequently, the spatial attention module 200 may calculate a spatial attention map. Each component of the spatial attention map may be referred to as a spatial attention level B_{j,i} between regions, e.g., pixels, and may be calculated by Equation 2. The spatial attention level B_{j,i}, which is a Softmax function value, may represent an extent to which the model attends to an i-th region when synthesizing a j-th region. In other words, the spatial attention level may denote a degree of influence of the i-th region on the j-th region.

$${β}_{j , i} = \frac{exp ( {s}_{ij} )}{{\sum }_{i = 1}^{H \times W} exp ( {s}_{ij} )} , where {s}_{ij} = F ( {x}_{i )}^{T} G ( {x}_{j} ) \qquad [ Equation 2 ]$$

The spatial attention module 200 may obtain a spatial feature vector by a matrix multiplication of the spatial attention map with the input data. That is, each component of the spatial feature vector may be expressed by Equation 3. The spatial feature vector may be constructed to reflect the weights by the multiplication of the spatial attention map by a value matrix.

$${o}_{j} = ( {\sum }_{i = 1}^{H \times W} {β}_{j , i} h ( {x}_{i} ) ) , where h ( {x}_{i} ) = {W}_{h} {x}_{i} \qquad [ Equation 3 ]$$

In the formulation above, W_{F}, W_{G}, and Wₕ are learned weight parameters, which may be implemented by respective 3D vectors having shapes of 1×1×1.

In an exemplary embodiment, the spatial attention module 200 may output the spatial feature vector expressed by the Equation 3 as a spatial feature map. Alternatively, however, the spatial attention module 200 may calculate a separate spatial self-attention feature vector by multiplying a scaling parameter to the spatial feature vector and adding the initial input video feature as shown in Equation 4 to output as the spatial feature map.

$${sa}_{i} = γ {o}_{i} + {x}_{i} \qquad [ Equation 4 ]$$

The temporal attention module 300 may receive the video features having a shape of C×T×H×W from the backbone network 100 through the RoI alignment unit 120, where C, T, H, W denote a number of channels, a temporal duration, a height, and a width, respectively. The temporal attention module 300 transforms the video features into C×T first features and H×W second features. The temporal attention module 300 may receive the transformed video features from the spatial attention module 200. Also, the data transformation may be performed by a separate member other than the spatial attention module 200 or the temporal attention module 300. Alternatively, the data transformation may just mean a selective use of only some portion of the video features stored in the memory rather than an actual data manipulation. Here, ‘C×T’ may represent a number of feature channels and temporal spaces, and ‘H×W’ may represent a number of spatial feature maps.

The temporal attention module 300 projects the transformed video features x ∈ R^{(C×T)×(H×W)} into two new feature spaces K, L according to Equation 5. This projection corresponds to a multiplication of a key matrix by a query matrix in the time axis domain.

$$K ( x ) = {W}_{K} x , L ( x ) = {W}_{L} x \qquad [ Equation 5 ]$$

Subsequently, the temporal attention module 300 may calculate a temporal attention map. Each component of the temporal attention map may be referred to as a temporal attention level a_{j,i} between regions, e.g., pixels, and may be calculated by Equation 6. The temporal attention level a_{j,i}, which is a Softmax function value, may represent an extent to which the model attends to an i-th region when synthesizing a j-th region. In other words, the spatial attention level β_{j,i} may denote a degree of influence of the i-th region on the j-th region.

$${α}_{j , i} = \frac{exp ( {t}_{ij} )}{{\sum }_{i = 1}^{C \times T} exp ( {t}_{ij} )} , where {t}_{ij} = K ( {x}_{i )}^{T} L ( {x}_{j} ) \qquad [ Equation 6 ]$$

The temporal attention module 300 may obtain a temporal feature vector by a matrix multiplication of the temporal attention map with the input data. That is, each component of the temporal feature vector may be expressed by Equation 7. The temporal feature vector may be constructed to reflect the weights by the multiplication of the temporal attention map by a value matrix.

$${m}_{j} = ( {\sum }_{i = 1}^{C \times T} {α}_{j , i} b ( {x}_{i} ) ) , where b ( {x}_{i} ) = {W}_{b} {x}_{i} \qquad [ Equation 7 ]$$

In the formulation above, W_{K}, W_{L}, and W_{b} are learned weight parameters, which may be implemented by respective 3D vectors having shapes of 1×1×1.

In an exemplary embodiment, the temporal attention module 300 may output the temporal feature vector expressed by the Equation 7 as a temporal feature map. Alternatively, however, the temporal attention module 300 may calculate a separate temporal self-attention feature vector by multiplying a scaling parameter to the temporal feature vector and adding the initial input video feature as shown in Equation 8 to output as the temporal feature map.

$${st}_{i} = γ {m}_{i} + {x}_{i} \qquad [ Equation 8 ]$$

Human actions may be divided into two categories: slow-moving actions and fast-moving actions. Most of the existing action recognition networks puts an emphasis on the slow actions and treated the fast actions as a kind of features. However, the inventors believe that the fast actions may be important at every moment while the slow actions are usually unnecessary but may be meaningful in rare cases. Therefore, according to an exemplary embodiment of the present disclosure, human actions are divided into the fast actions and the slow actions, and the feature maps are extracted separately for the fast actions and the slow actions. That is, a kernel used in the convolution operation used in each of the spatial attention module 200 and the temporal attention module 300 are differentiated to separately extract the feature map for the slow action and that for the fast action.

That is, the spatial attention module 200 may include a first kernel for the slow action recognition and a second kernel for the fast action recognition to store the transformed (i.e., projected) video features to be provided to a convolution operator. The first kernel may have a shape of 7×1×1, for example, and the second kernel may have a shape of 1×1×1, for example. The larger first kernel may be used to store the transformed video features during the process of calculating the feature map for the slow action recognition. The smaller second kernel may be used to store the transformed video features during the process of calculating the feature map for the fast action recognition. In an embodiment, only one of the first and second kernels may operate at each moment under a control of a controller. Alternatively, however, the first kernel and the second kernel may operate simultaneously, so that both the feature map for the slow action recognition and the feature map for the fast action recognition may be calculated and concatenated by the concatenator 400.

The temporal attention module 300 may include a third kernel for the slow action recognition and a fourth kernel for the fast action recognition to store the transformed video features to be provided to a convolution operator. The third kernel may have a shape of 7×1×1, for example, and the fourth kernel may have a shape of 1×1×1, for example. The larger third kernel may be used to store the transformed video features during the process of calculating the feature map for the slow action recognition. The smaller fourth kernel may be used to store the transformed video features during the process of calculating the feature map for the fast action recognition. In an embodiment, only one of the third and fourth kernels may operate at each moment under the control of the controller. Alternatively, however, the third kernel and the fourth kernel may operate simultaneously, so that both the feature map for the slow action recognition and the feature map for the fast action recognition may be calculated and concatenated by the concatenator 400. In this case, the two feature maps from the spatial attention module 200 and the two feature maps from the temporal attention module 300 may be concatenated by the connection unit 400.

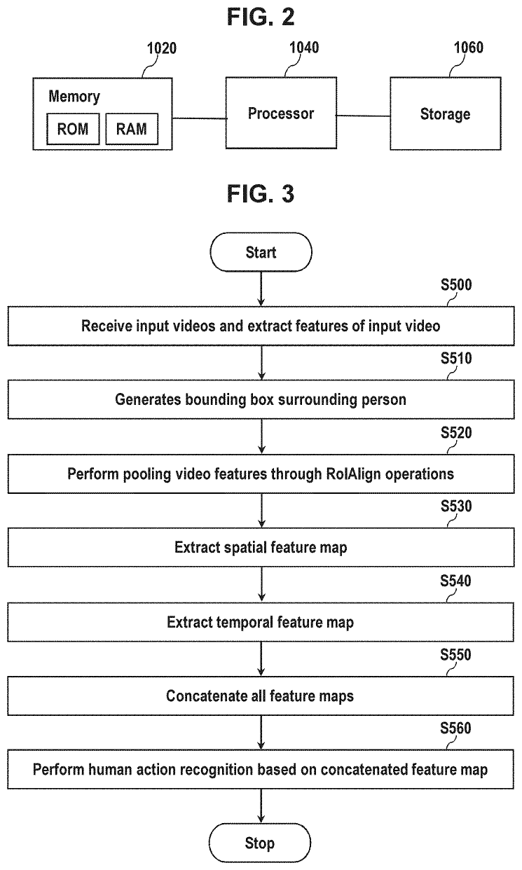

FIG. 2 is a block diagram of an action recognition apparatus according to an exemplary embodiment of the present disclosure. The action recognition apparatus according to an embodiment of the present disclosure may include a processor 1020, a memory 1040, and a storage 1060.

The processor 1020 may execute program instructions stored in the memory 1020 and/or the storage 1060. The processor 1020 may be a central processing unit (CPU), a graphics processing unit (GPU), or another kind of dedicated processor suitable for performing the methods of the present disclosure.

The memory 1040 may include, for example, a volatile memory such as a read only memory (ROM) and a nonvolatile memory such as a random access memory (RAM). The memory 1040 may load the program instructions stored in the storage 1060 to provide to the processor 1020.

The storage 1060 may include an intangible recording medium suitable for storing the program instructions, data files, data structures, and a combination thereof. Any device capable of storing data that may be readable by a computer system may be used for the storage. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The program instructions stored in the memory 1040 and/or the storage 1060 may implement an action recognition method according to an exemplary embodiment of the present disclosure. Such program instructions may be executed by the processor 1020 in a state of being loaded into the memory 1040 under the control of the processor 1020 to implement the method according to the present disclosure.

FIG. 3 is a flowchart showing the action recognition method according to an exemplary embodiment of the present disclosure.

First, the backbone network 100 receives a certain number of video frames as one video data unit and extracts features of the input videos (S500). Subsequently, the bounding box generator 110 finds a location of a person in the video who may be the target of the action recognition, based on the input video features output by the backbone network 100, and generates the bounding box surrounding the person (S510). The RoI alignment unit 120 may pool the video features from the backbone network 100 through RoIAlign operations with reference to the bounding box information (S520).

Next, the spatial attention module 200 may extract the spatial feature map from the RoIAligned video features (S530). Meanwhile, the temporal attention module 300 may extract the temporal feature map from the RoIAligned video features (S540). In operation S550, the concatenator 400 may concatenate all the feature maps extracted by the spatial attention module 200 and the temporal attention module 300 to create a concatenated feature map. Finally, the determining unit 420 may perform the human action recognition based on the concatenated feature map (S560).

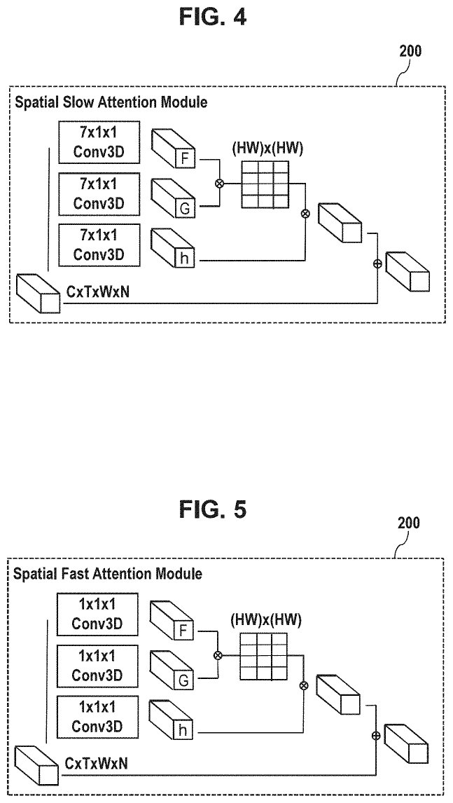

FIG. 4 is an illustration for explaining a process of generating the feature map for the spatially slow action. The self-attention mechanism may include matrix operations of the key, query, and value matrices. The key matrix and the query matrix can be projected into a different dimensions by a three-dimensional (3D) convolutional neural network. In this case, the window size of the spatial axis is set to be large to be suitable for the extraction of the feature map for the spatially slow action, so that the features for several frames may be extracted. Afterwards, the matrix multiplication of the key matrix and the query matrix may be performed in the spatial axis domain, and the self-attention map may be generated using the Softmax function. Then, the weight may be reflected by multiplying the generated self-attention map by the value matrix.

FIG. 5 is an illustration for explaining a process of generating the feature map for the spatially fast action. The key matrix and the query matrix can be projected into a different dimensions by the 3D convolutional neural network. In this case, the window size of the spatial axis is set to be small to be suitable for the extraction of the feature map for the spatially fast action, so that the features for a single frame may be extracted. Afterwards, the matrix multiplication of the key matrix and the query matrix may be performed in the spatial axis domain, and the self-attention map may be generated using the Softmax function. Then, the weight may be reflected by multiplying the generated self-attention map by the value matrix.

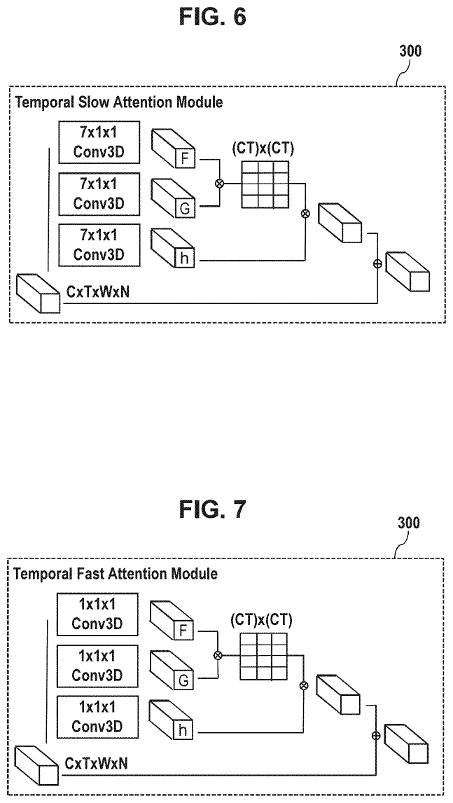

FIG. 6 is an illustration for explaining a process of generating the feature map for the temporally slow action. The key matrix and the query matrix can be projected into a different dimensions by the 3D convolutional neural network. In this case, the window size of the temporal axis is set to be large to be suitable for the extraction of the feature map for the temporally slow action, so that the features for several frames may be extracted. Afterwards, the matrix multiplication of the key matrix and the query matrix may be performed in the temporal axis domain, and the self-attention map may be generated using the Softmax function. Then, the weight may be reflected by multiplying the generated self-attention map by the value matrix.

FIG. 7 is an illustration for explaining a process of generating the feature map for the temporally fast action. The key matrix and the query matrix can be projected into a different dimensions by the 3D convolutional neural network. In this case, the window size of the temporal axis is set to be small to be suitable for the extraction of the feature map for the temporally fast action, so that the features for a single frame may be extracted. Afterwards, the matrix multiplication of the key matrix and the query matrix may be performed in the temporal axis domain, and the self-attention map may be generated using the Softmax function. Then, the weight may be reflected by multiplying the generated self-attention map by the value matrix.

The inventors evaluated the action recognition method according to an exemplary embodiment of the present disclosure by using AVA dataset. The AVA dataset is Chunhui Gu, Chen Sun, et al., “Ava: A video dataset of spatiotemporally localized atomic visual actions,” in Proceedings of the IEEE Conference on Computer Vision and Pattern Recognition, 2018, pp. 6047-6056, and consists of 80 action classes. Each class is largely divided into three categories: individual behavior, behaviors related to people, and behaviors related to objects. The AVA dataset includes a total of 430 videos which are split into 235 for training, 64 for validation, and 131 for test. Each video is a 15 minute long video clip and includes one annotation per second. The inventors evaluated 60 classes as the other researcher's evaluations and used at least 25 instances for validation. Frame level average precision (frame-AP) was used as an evaluation index, and intersection of union (IoU) threshold was set to 0.5 in center frame of video clip.

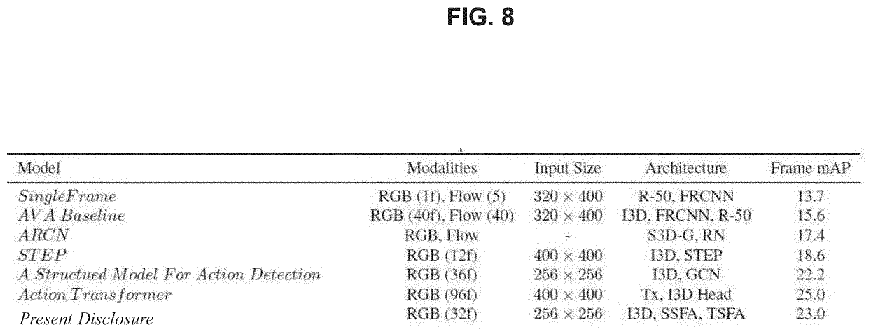

FIG. 8 is a table summarizing performance evaluation results of the action recognition method of the present disclosure and conventional methods performed using the AVA dataset. In the table, The Single Frame model and AVA Baseline model are disclosed in Chunhui Gu, et al., “Ava: A video dataset of spatiotemporally localized atomic visual actions,” in Proceedings of the IEEE Conference on Computer Vision and Pattern Recognition, 2018, pp. 6047-6056. The ARCN model is disclosed in Chen Sun, et al., “Actor-centric relation network,” in Proceedings of the European Conference on Computer Vision (ECCV), 2018, pp. 318-334. The STEP model is disclosed in Xitong Yang, et al., “Step: Spatiotemporal progressive learning for video action detection,”in Proceedings of the IEEE Conference on Computer Vision and Pattern Recognition, 2019, pp. 264-272. The structured Model for Action Detection is disclosed in Yubo Zhang, et al., “A structured model for action detection,”in Proceedings of the IEEE Conference on Computer Vision and Pattern Recognition, 2019, pp. 9975-9984. The Action Transformer model is disclosed in Rohit Girdhar, et al., “Video action transformer network,” in Proceedings of the IEEE Conference on Computer Vision and Pattern Recognition, 2019, pp. 244-253.

While early stage action recognition networks have used both the RGB image and optical flow features, recently developed networks are using only the RGB images owing to the use of more abundant features such as Graph Convolutional Network (GCN) and Attention Mechanism. It can be seen, in Table 1, that From Table 1, it can be seen that the recognition method of the present disclosure can obtain meaningful results using fewer image frames and lower resolution compared to other networks.

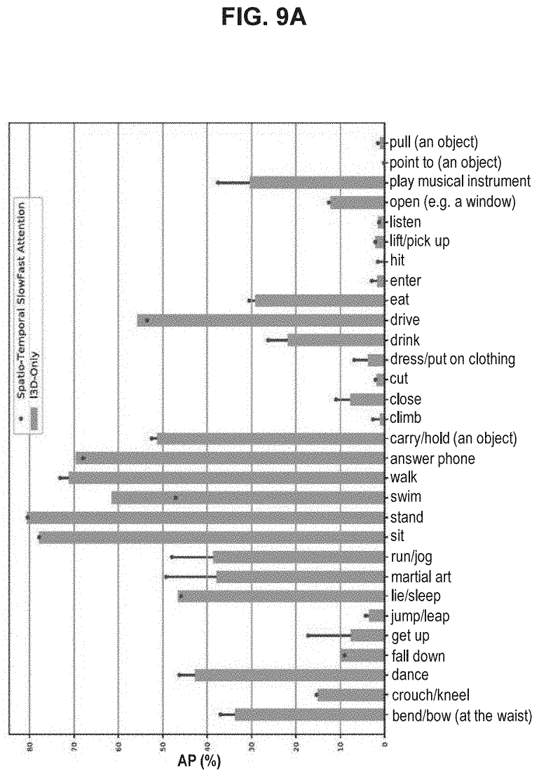

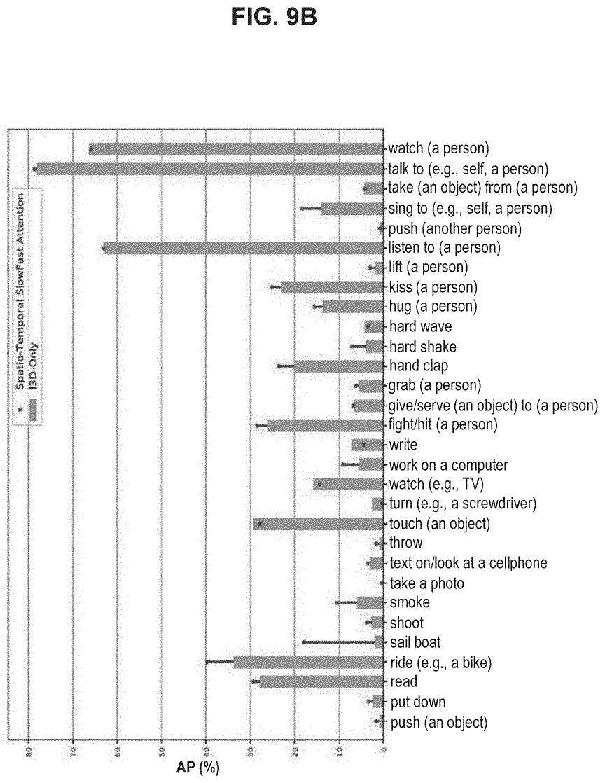

FIGS. 9A and 9B are graphs showing comparison results of the frame APs for the cases with and without the spatio-temporal self-attention mechanism according to the present disclosure. When the spatio-temporal self-attention mechanism of the present disclosure was used, the performance improved in 39 classes, and in particular, the high performances occurred for low-performance classes such as those associated with interactions with objects or interactions with other humans. The reason is that the spatio-temporal self-attention mechanism is applied to the features obtained through RoIPool, allowing the network to focus more on objects or humans in the surrounding pooled context. Therefore, it can be said that the spatio-temporal self-attention mechanism of the present disclosure may be useful for the long-range interactions.

As described above, the spatio-temporal self-attention mechanism according to an exemplary embodiment of the present disclosure may extract important spatial information, temporal information, slow action information, and fast action information from the input videos. The proposed features may play major roles in distinguishing action classes. Experiments revealed that the method of the present disclosure may achieve remarkable performances compared to the conventional networks while using less amount of resources and having simpler structure.

As mentioned above, the apparatus and method according to exemplary embodiments of the present disclosure can be implemented by computer-readable program codes or instructions stored on a computer-readable intangible recording medium. The computer-readable recording medium includes all types of recording media storing data readable by a computer system. The computer-readable recording medium may be distributed over computer systems connected through a network so that a computer-readable program or code may be stored and executed in a distributed manner.

The computer-readable recording medium may include a hardware device specially configured to store and execute program commands, such as ROM, RAM, and flash memory. The program commands may include not only machine language codes such as those produced by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An action recognition method, comprising:
acquiring video features for input videos;
generating a bounding box surrounding a person who may be a target for an action recognition;
pooling the video features based on bounding box information;
extracting at least one spatial feature map from pooled video features;
extracting at least one temporal feature map from pooled video features;
concatenating the at least one spatial feature map and the at least one temporal feature map to generate a concatenated feature map; and
performing a human action recognition based on the concatenated feature map.

2. The action recognition method of claim 1, wherein pooling the video features is performed through RoIAlign operations.

3. The action recognition method of claim 1, wherein extracting at least one spatial feature map comprises a process of generating a feature map for a spatially fast action and a process of generating a feature map for a spatially slow action.

4. The action recognition method of claim 3, wherein extracting at least one temporal feature map comprises a process of generating a feature map for a temporally fast action and a process of generating a feature map for a temporally slow action.

5. The action recognition method of claim 4, wherein each of the process of generating the feature map for the spatially fast action and the process of generating the feature map for the spatially slow action comprises:
projecting the pooled video features into two new feature spaces;
calculating a spatial attention map having components representing influences between spatial regions; and
obtaining a spatial feature vector by performing a matrix multiplication of the spatial attention map with input video data.

6. The action recognition method of claim 5, wherein each of the process of generating the feature map for the spatially fast action and the process of generating the feature map for the spatially slow action further comprises:
generating the spatial feature map by multiplying a first scaling parameter to the spatial feature vector and adding the video feature.

7. The action recognition method of claim 4, wherein each of the process of generating the feature map for the temporally fast action and the process of generating the feature map for the temporally slow action comprises:
projecting the pooled video features into two new feature spaces;
calculating a temporal attention map having components representing influences between temporal regions; and
obtaining a temporal feature vector by performing a matrix multiplication of the temporal attention map with the input video feature.

8. The action recognition method of claim 7, wherein each of the process of generating the feature map for the temporally fast action and the process of generating the feature map for the temporally slow action further comprises:
generating the temporal feature map by multiplying a second scaling parameter to the temporal feature vector and adding the video feature.

9. An apparatus for recognizing a human action from videos, comprising:
a processor; and
a memory storing program instructions to be executed by the processor,
wherein the program instructions, when executed by the processor, causes the processor to:
acquire video features for input videos;
generate a bounding box surrounding a person who may be a target for an action recognition;
pool the video features based on bounding box information;
extract at least one spatial feature map from pooled video features;
extract at least one temporal feature map from pooled video features;
concatenate the at least one spatial feature map and the at least one temporal feature map to generate a concatenated feature map; and
perform a human action recognition based on the concatenated feature map.

10. The apparatus of claim 9, wherein the program instructions causing the processor to pool the video features causes the processor to pool the video features through RoIAlign operations.

11. The apparatus of claim 9, wherein the program instructions causing the processor to extract the at least one spatial feature map comprise instructions causing the processor to:
generate a feature map for a spatially fast action; and
generate a feature map for a spatially slow action.

12. The apparatus of claim 3, wherein the program instructions causing the processor to extract the at least one temporal feature map comprise instructions causing the processor to:
generate a feature map for a temporally fast action; and
generate a feature map for a temporally slow action.

13. The apparatus of claim 12, wherein each of the program instructions causing the processor to generate the feature map for the spatially fast action the program instructions causing the processor to generate the feature map for the spatially slow action comprise instructions causing the processor to:
project the pooled video features into two new feature spaces;
calculate a spatial attention map having components representing influences between spatial regions; and
obtain a spatial feature vector by performing a matrix multiplication of the spatial attention map with input video data.

14. The apparatus of claim 13, wherein each of the program instructions causing the processor to generate the feature map for the spatially fast action the program instructions causing the processor to generate the feature map for the spatially slow action further comprise instructions causing the processor to:
generate the spatial feature map by multiplying a first scaling parameter to the spatial feature vector and adding the video feature.

15. The apparatus of claim 12, wherein each of the program instructions causing the processor to generate the feature map for the temporally fast action the program instructions causing the processor to generate the feature map for the temporally slow action comprise instructions causing the processor to:
project the pooled video features into two new feature spaces;
calculate a temporal attention map having components representing influences between temporal regions; and
obtain a temporal feature vector by performing a matrix multiplication of the temporal attention map with the input video feature.

16. The apparatus of claim 15, wherein each of the program instructions causing the processor to generate the feature map for the temporally fast action the program instructions causing the processor to generate the feature map for the temporally slow action further comprise instructions causing the processor to:
generate the temporal feature map by multiplying a second scaling parameter to the temporal feature vector and adding the video feature.
